(19) United States
(12) Patent Application Publication
(10) Pub. No.: US 2026/0174526 A1
(43) Pub. Date: Jun. 25, 2026

(54) PROSTHETIC SCREW FOR ATTACHING A PROSTHETIC TO A MULTI-UNIT ABUTMENT (MUA) FOR DENTAL IMPLANTS AND ASSOCIATED METHODS

(71) Applicant: Smart Mouth Technologies, LLC, Bozeman, MT (US)

(72) Inventors: Sven Bone, Bozeman, MT (US); Isaac Copeland, Bozeman, MT (US)

(73) Assignee: Smart Mouth Technologies, LLC, Bozeman, MT (US)

(21) Appl. No.: 18/991,517

(22) Filed: Dec. 21, 2024

(51) Int. Cl. A61C 8/00

(52) U.S. Cl. CPC A61C 8/0068; A61C 8/0022

(57) ABSTRACT

The prosthetic screw is for securing dental or bone-implant prosthetics to anchors, such as multi-unit abutments (MUAs). The screw includes a body with a threaded bottom portion for attachment, a head portion at the top for tool engagement, and a midsection with a curved transition profile. This curved profile eliminates right angles, evenly distributes vertical clamping forces, and reduces stress on the prosthetic, enhancing durability. The design accommodates prosthetics made from materials such as zirconia, PMMA, 3D printable photopolymer resin, and titanium, with thread sizes including M1.4, M1.6, and M1.72. The head's larger diameter facilitates secure attachment and stress management. The screw ensures reliable attachment, stress moderation, and extended functionality in dental and bone-implant systems.

### FIELD OF THE INVENTION

The present invention relates to dental prosthetics, and more specifically to healing scan caps for dental implants.

### BACKGROUND

In dentistry, for full-arch implant prosthetics, the goal of the treatment is to replace missing teeth or hopeless teeth with fixed prostheses anchored to dental implants. The prostheses are designed in dental CAD software prior to the surgery. Traditionally, immediate dentures would be fabricated and attached to the dental implants at the time of surgery. Currently, the state of art technology is pushing towards completely digital workflows. Traditional pre-op impressions have been replaced by intraoral scanners. Traditional implant impressions have been replaced by photogrammetry base scanners. This transition to digital workflows improves implant positional data accuracy and reproducibility, provisional design and quality, and reduced patient chair-time.

Full-arch implant prostheses are challenging to design as they must replace a patient's teeth in both function and form. Each prosthetic is patient-specific, must withstand repetitive chewing and biting forces, be biocompatible within the mouth, and maintain the aesthetics of the mouth and face. The current material of choice for prosthetics is yttria-stabilized zirconia due to its mechanical strength, biocompatibility, ease of manufacture, and aesthetic properties. However, zirconia prosthetics can fail due to screws loosening or fracture around the screw channel.

Two common methods for attaching zirconia prosthetics to multi-unit abutments (MUAs) are using a titanium base (Ti-base) as an interface between the prosthetic and the screw or screwing the prosthetic directly to the MUA. Ti-base prosthetics introduce an additional failure point at the bond between the zirconia ceramic and the Ti-base, which can fail during the lifespan of the prosthetic. They also require a larger screw channel to be designed into the prosthetic, making it more difficult for the designer to maintain minimum material thickness and aesthetics successfully.

The direct approach provides a simple option with a comparable lifespan and mechanical strength to Ti-base prosthetics while relying on fewer components in each prosthetic. This approach is easier to manufacture and can have smaller screw channels. However, the forces from tightening the screws are directly exerted on the zirconia.

Current direct-to-MUA screws available on the market have room for improvement in optimizing their effectiveness in securing the prosthetic to the MUAs while minimizing the stress exerted on the prosthetics. Popular options like the Dess screw and Rosen screw have contrasting designs, with the Dess screw relying on clamping force and the Rosen screw relying mostly on friction to provide stability.

There is room for improvement as screws should be designed to provide more clamping force than the Rosen screw while still minimizing the stress experienced by the implant.

This background information is provided to reveal information believed by the applicant to be of possible relevance to the present invention. No admission is necessarily intended, nor should be construed, that any of the preceding information constitutes prior art against the present invention.

### SUMMARY

The present application discloses embodiments that relate to a prosthetic screw designed for attaching dental prosthetics or bone-implant prosthetics to anchors such as multi-unit abutments. The screw comprises a body with a threaded portion at the bottom for secure attachment, a head portion at the top for tool engagement during tightening, and a midsection with a curved transition profile. This curved profile, which eliminates right angles, is specifically designed to distribute vertical clamping forces evenly and reduce stress on the prosthetic, improving its durability and performance.

The embodiments are compatible with various prosthetic materials, including zirconia, PMMA, 3D printable photopolymer resin, and titanium, and can be produced with thread sizes such as M1.4, M1.6, and M1.72. The screw's design includes a head portion with a larger diameter than the threaded body, ensuring efficient force distribution and secure attachment. Additionally, the invention encompasses a method of manufacturing the prosthetic screw, focusing on forming the curved transition profile to enhance compatibility with prosthetic components. This screw design aims to improve functionality, longevity, and stress management in dental and bone-implant systems.

In summary, the invention offers a novel approach for securing prosthetics (e.g. zirconia prosthetics) directly to MUAs in full-arch implant prosthetic treatments. The concave head profile and smaller diameter screw head address the limitations of existing screws by reducing stress in the prosthetic, maintaining vertical clamping force, and accommodating a smaller screw channel. This innovative design enhances the longevity and stability of the prosthetic while providing more flexibility in implant placement and prosthetic design.

### BRIEF DESCRIPTION OF THE DRAWINGS

The figures which accompany the written portion of this specification illustrate embodiments and method(s) of use according to the teachings of the present invention.

FIG. 1 is an orthographic view illustrating a dental prosthetic screw for use in dental surgery according to an embodiment of the present invention.

FIG. 2 is an elevation section view illustrating a dental prosthetic for accommodating the dental prosthetic screw of FIG. 1, in accordance with the example embodiments.

FIG. 3 is an elevation section view illustrating an installed dental prosthetic screw and accompanying threaded abutment, according to an embodiment of the present invention.

FIG. 4 is an elevation section view illustrating a fully assembled system including an installed dental prosthetic screw, dental prosthetic and accompanying threaded abutment.

The figures are schematic, not necessarily to scale, and generally only shows parts which are necessary to elucidate example embodiments, wherein other parts can be omitted or merely suggested.

The various embodiments of the present invention will hereinafter be described in conjunction with the appended drawings, wherein like designations denote like elements.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

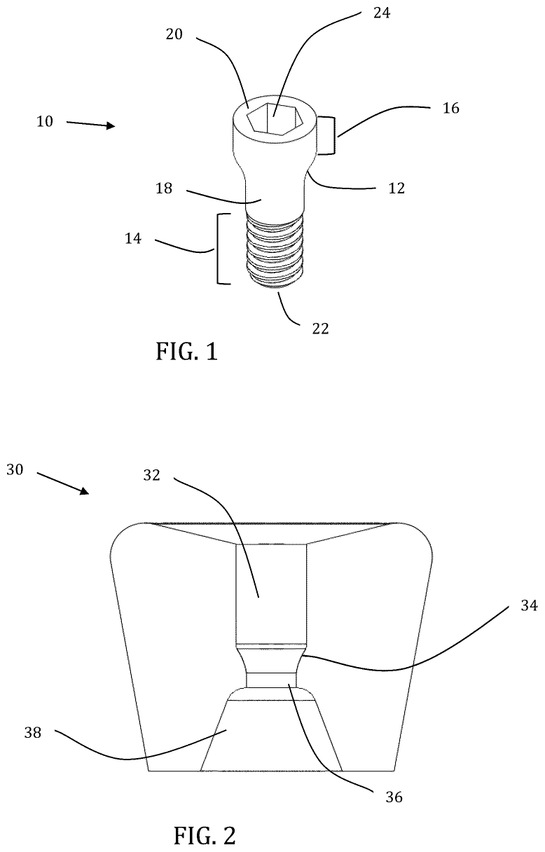

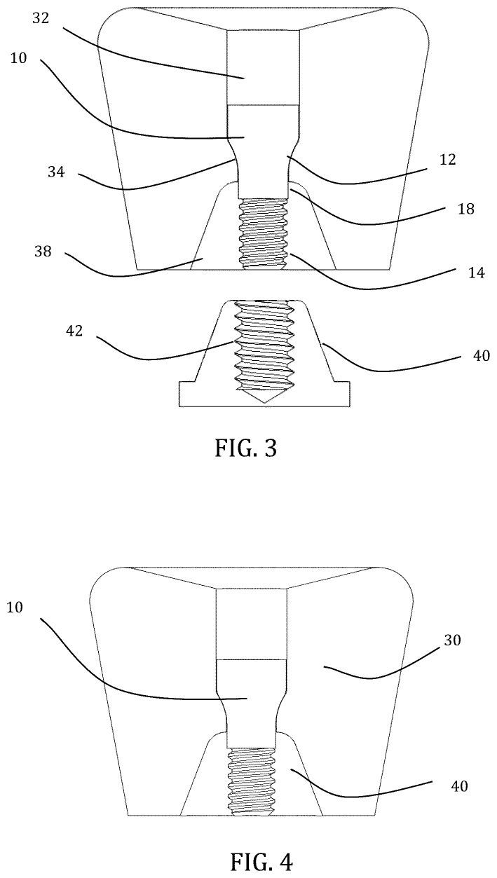

With reference to FIGS. 1-4, embodiments of the dental prosthetic screw 10 and associated method designed for use with a single abutment or multi-unit abutments (MUAs) in dental implant procedures, will be described. FIG. 1 is an orthographic view illustrating the dental prosthetic screw 10. FIG. 2 is an elevation section view illustrating a dental prosthetic 30 for accommodating the dental prosthetic screw 10. FIG. 3 is an elevation section view illustrating an installed dental prosthetic screw 10 and accompanying threaded abutment 40. FIG. 4 is an elevation section view illustrating a fully assembled system including an installed dental prosthetic screw 10, dental prosthetic 30 and accompanying threaded abutment 40.

The dental prosthetic screw 10 includes a body with a top or head 16, shaft 18, and a threaded portion 14. The midsection defining a transition 12 from the shaft portion 18 to the head 16, has a curved profile (e.g. a concave profile) and is without right angles. The threaded portion 14 (e.g. M1.4, M1.6, or M1.72 threads) extends partially or fully along the length of the shaft 18 and terminates fully at the bottom 22. The prosthetic screw 10 includes a driver receiver 24 located along the top 20 of the head portion 16 to accommodate a driver (not shown). The illustration of this embodiment depicts a hexagonal driver receiver; however, the device can be constructed to include any driver shape available.

Referring to FIG. 2, the dental prosthetic 30 is illustrated in this figure as a single tooth but can be implemented in multiple tooth or full arch prosthetics. The prosthetic may be a zirconia, PMMA (polymethyl methacrylate), 3D printable photopolymer resin, and/or a titanium substructure prosthetic as would be appreciated by those skilled in the art. The dental prosthetic 30 features a screw bore profile 32 that is cylindrical in shape and includes a shaft opening 36 to allow the prosthetic screw 10 to pass through and deliver the threaded portion 14 to the abutment bore opening 38. The screw bore profile 32 compliments the head portion 16 along the diameter and is deep enough to allow the head portion 16 to sit fully within the bore. Importantly the profile includes a curved sidewall 34 to contact fully against the screw's curved portion 12.

FIGS. 3 and 4 illustrate a single tooth dental prosthetic 30 installed on a dental abutment 40. This connection is made from the threaded portion 14 and tightened into the threaded bore 42. This threaded connection is torqued to a known value to fully seat the curved portion 12 of the screw 10 into the complimentary curved sidewall profile 34. The abutment 40 sits within the abutment bore opening 38.

Thus, the concave head profile removes right angles where the screw clamps and spreads out the force of the screw being tightened. This invention reduces the chances of an over-tightened screw fracturing the prosthetic or fatigue failure at the screw connection due to chewing. The screw is designed to increase the vertical clamping force compared to screws such as the Rosen, improving the stability and retention of the prosthetic and making the screw less likely to loosen during its lifespan.

The smaller diameter screw head allows for a smaller screw channel in the prosthetic, resulting in less material removal, making the prosthetic stronger and easier to design when following minimum material thickness recommendations. It also provides more flexibility in implant placement while still meeting the design requirements of the prosthetic.

The screw may be made of biocompatible Grade V titanium alloy, to ensure compatibility with a zirconia prosthetic and the oral environment. The thread design and dimensions are enhanced for secure engagement with the MUA while minimizing stress concentrations.

Some of the illustrative aspects of the present invention may be advantageous in solving the problems herein described and other problems not discussed which are discoverable by a skilled artisan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The foregoing disclosure provides illustration and description, but is not intended to be exhaustive or to limit the implementations to the precise form disclosed. Modifications and variations are possible in light of the above disclosure or may be acquired from practice of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of any included abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A prosthetic screw for attaching a dental prosthetic to a multi-unit abutment (MUA) for dental implants, the prosthetic screw comprising:
a body configured to extend through the prosthetic;
a bottom of the body includes a threaded portion configured to screw into the MUA;
a top of the body includes a head portion configured to receive a tool for turning the body during a tightening procedure; and
a midsection of the body includes a transition portion between the threaded portion and the head portion;
wherein the transition portion includes a curved profile configured to distribute a vertical clamping force on the prosthetic and moderate stress thereon.

2. The prosthetic screw according to claim 1, wherein the dental prosthetic comprises at least one of a zirconia, PMMA (polymethyl methacrylate), 3D printable photopolymer resin, and a titanium substructure prosthetic.

3. The prosthetic screw according to claim 1, wherein the threaded portion comprises at least one of M1.4, M1.6, or M1.72 threads.

4. The prosthetic screw according to claim 1, wherein the transition portion includes the curved profile without any right angles between the transition portion and the head portion.

5. The prosthetic screw according to claim 1, wherein the curved profile comprises a concave profile.

6. The prosthetic screw according to claim 1, wherein the top of the body has a greater diameter than the bottom of the body; and wherein the curved profile of the transition portion transitions the diameter of the top to the bottom of the body.

7. A prosthetic screw for attaching a prosthetic to an anchor or abutment for bone implants, the prosthetic screw comprising:
a body configured to extend through the prosthetic;
a bottom of the body includes a threaded portion;
a top of the body includes a head portion configured to receive a tool for turning the body; and
a midsection of the body includes a transition portion between the threaded portion and the head portion;
wherein the transition portion includes a curved profile, without any right angles between the transition portion and the head portion, and configured to distribute a vertical clamping force on the prosthetic and moderate stress thereon.

8. The prosthetic screw according to claim 7, wherein the prosthetic comprises at least one of a zirconia, PMMA (polymethyl methacrylate), 3D printable photopolymer resin, and a titanium substructure prosthetic.

9. The prosthetic screw according to claim 7, wherein the threaded portion comprises at least one of M1.4, M1.6, or M1.72 threads.

10. The prosthetic screw according to claim 7, wherein the curved profile comprises a concave profile.

11. The prosthetic screw according to claim 7, wherein the top of the body has a greater diameter than the bottom of the body; and wherein the curved profile of the transition portion transitions the diameter of the top to the bottom of the body.

12. A method of making a prosthetic screw for attaching a prosthetic to an anchor for bone implants, the method comprising:
forming a body configured to extend through the prosthetic;
a bottom of the body includes a threaded portion configured to screw into the anchor;
a top of the body includes a head portion configured to receive a tool for turning the body during a tightening procedure;
a midsection of the body includes a transition portion between the threaded portion and the head portion;
forming the transition portion to include a curved profile, without any right angles between the transition portion and the head portion, and configured to distribute a vertical clamping force on the prosthetic and moderate stress thereon.

13. The method according to claim 12, wherein the prosthetic comprises at least one of a zirconia, PMMA (polymethyl methacrylate), 3D printable photopolymer resin, and a titanium substructure prosthetic.

14. The method according to claim 12, wherein the threaded portion comprises at least one of M1.4, M1.6, or M1.72 threads.

15. The method according to claim 12, wherein the curved profile comprises a concave profile.

16. The method according to claim 12, wherein the top of the body has a greater diameter than the bottom of the body; and wherein the curved profile of the transition portion transitions the diameter of the top to the bottom of the body.

17. The method according to claim 12, wherein the prosthetic comprises a dental prosthetic and the anchor comprises a multi-unit abutment (MUA) for dental implants.

18. The method according to claim 12, wherein the prosthetic comprises a screw hole having a profile corresponding to the curved profile of the transition portion.
